(19) United States
(12) Patent Application Publication
(10) Pub. No.: US 2018/0005307 A1
(43) Pub. Date: Jan. 4, 2018

(54) SYSTEM CONFIGURATIONS WITH APPLIANCES AND VEHICLES

(71) Applicant: PAYPAL, INC., San Jose, CA (US)

(72) Inventor: Sheikh Ashraful Abedin, San Francisco, CA (US)

(21) Appl. No.: 15/196,895

(22) Filed: Jun. 29, 2016

(51) Int. Cl. G06Q 30/06; G06Q 20/36; G06Q 10/00; G06Q 10/06; H04L 12/28; G05B 15/02; G06Q 50/30

(52) U.S. Cl. CPC G06Q 30/0635; H04L 12/2816; G06Q 20/36; G05B 15/02; G06Q 10/20; G06Q 10/06311; G06Q 50/30

(57) ABSTRACT

Various systems, mediums, and methods for self-maintaining appliances and vehicles may involve receiving data generated by at least one sensor associated with the appliance or vehicle. A requirement associated with amounts of the items of the appliance, a service requirement of the appliance, or a service requirement of the vehicle is determined. Available items or available services in the marketplace network are identified. An available budget of the appliance or the vehicle for obtaining the available items or available services is determined. A purchase order for retrieving the available items or a service order for retrieving the available services is sent to the marketplace network.

### BACKGROUND

Embodiments disclosed herein are related to systems and methods for operations of appliances and vehicles.

A user of a dishwasher when intending to start a run on the dishwasher may recognize the detergent bottle is empty. Likewise, a user of a vehicle when intending to start the vehicle may recognize the gas tank is empty. As a result, the user may be unable to fully utilize the appliance or vehicle, if at all.

Additionally, control systems may be placed in the vehicle to make the vehicles self-driving. For example, the map coordinates of an intended location can be given to a self-driving car and the self-driving car can then go to the intended location by itself. However, self-driving vehicles typically are only able to travel between locations and are thus limited in what they can do.

There is therefore a need for a device, system, and method for improving the operations of the appliances and vehicles.

### BRIEF DESCRIPTION OF THE FIGURES

1A is a block diagram of an exemplary self-maintaining system for an appliance, according to some embodiments.

FIG. 1B is a block diagram of an exemplary self-maintaining system for an appliance, according to some embodiments.

FIG. 1C is a block diagram of an exemplary self-maintaining system for an appliance, according to some embodiments.

FIG. 2 is a block diagram of an exemplary digital wallet of a self-maintaining system, according to some embodiments.

FIG. 3 is a block diagram of an exemplary self-maintaining system for an appliance, according to some embodiments.

FIG. 4A is a block diagram of an exemplary system of a plurality of self-maintaining appliances, according to some embodiments.

FIG. 4B is a block diagram of an exemplary self-maintaining system for a plurality of appliances, according to some embodiments.

FIG. 5 is a block diagram of an exemplary self-maintaining system for a vehicle, according to some embodiments.

FIG. 6 is a block diagram of an exemplary system of a fleet of self-maintaining vehicles, according to some embodiments.

FIG. 7 illustrates an exemplary self-maintaining method for an appliance, according to some embodiments.

FIG. 8 illustrates an exemplary self-maintaining method for an appliance, according to some embodiments.

FIG. 9 illustrates an exemplary self-maintaining method for a vehicle, according to some embodiments.

FIG. 10 illustrates an exemplary self-maintaining method for a vehicle, according to some embodiments.

Embodiments of the present disclosure and their advantages may be understood by referring to the detailed description provided herein. It should be appreciated that reference numerals may be used to illustrate various elements and/or features provided in the figures.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

In some embodiments, a system provides one or more operations for self-maintaining a household appliance device and/or a vehicle. Notably, the household appliance device may be referred to as an appliance device and/or a device. Further, the vehicle may be referred to a vehicle device and/or a device, among other possibilities. The self-maintaining system is provided with a budget and may be coupled to a marketplace network and may use the budget to purchase the required items from the marketplace network. In some examples, the household appliance is a washing machine and the required item is a detergent item. Then the system allows the washing machine to purchase the detergent item from the marketplace network. In addition, the system provides self-maintaining of a vehicle and the required item is gasoline and the vehicle may use the budget to purchase the service of filling up gasoline from the marketplace network. In some examples, the vehicle is a self-driving car and the self-driving car may drive to the marketplace location to obtain the service of filling up the tank with gasoline. In some other examples, the vehicle is a self-driving car and the self-driving car may drive to a parking space to park the vehicle and the vehicle may use the budget to pay for the parking fee.

Consistent with some embodiments, there is provided a system having a non-transitory memory. The system includes one or more hardware processors that are configured to execute instructions. The instructions when executed as one or modules by the one or more hardware processors can cause the system to perform operations described herein.

In some embodiments, the system receives data generated by at least one sensor. The sensors may be associated with an appliance. The received data corresponds to an amount one or more items of the appliance. In some examples, the appliance is a household appliance such as a dishwasher and the sensor is associated with the dishwasher. The item is dishwasher soap and/or detergent and the data generated by the sensors corresponds to an amount of soap and/or detergent of the dishwasher.

In some embodiments, the system determines a requirement associated with the amount of the one or more items. The requirement is determined based on the received data. As noted above, in some examples, the appliance is a dishwasher and the requirement is the required size and brand of the dishwasher detergent.

In some embodiments, the system identifies one or more available items from a marketplace network. The one or more available items may satisfy the requirement, where satisfying the requirement is meeting a predetermined amount for the one or more items associated with the appliance, or possibly increasing the amount of the one or more items associated with the appliance. In some examples, the system receives the information of different brands with their sizes and prices. As such, the system may identify the one or more available items based on the information received, possibly based on the information on the different brands. As noted above, in some examples, the appliance is a dishwasher and the identification includes receiving the information of different brands with sizes and prices of dishwasher detergent that satisfy the required dishwasher detergent.

In some embodiments, the system determines an available budget to purchase the one or more available items. Determining the available budget may include determining the available budget is sufficient to purchase the one or more available items from the marketplace network. As noted above, in some examples, the appliance is a dishwasher and it is determined if there is available budget to purchase one of the available brands and sizes of dishwasher detergent that satisfy the required dishwasher detergent.

In some embodiments, an order is sent to the marketplace network to retrieve the one or more available items. In some examples, retrieving the one or more available items includes making a payment to purchase the one or more available items to receive the one or more available items. As noted above, in some examples, the appliance is a dishwasher and an order is sent to the marketplace network to retrieve one of the available brands of dishwasher detergent that satisfy the required dishwasher detergent.

Consequently, as described, embodiments described herein may allow an appliance to initiate on its own to acquire the items, e.g., consumables, associated with the appliance from the marketplace network, based on sensors or detectors associated with the appliance that indicates a need for the item or items. As noted above, in some examples, the appliance is a dishwasher and the embodiments described herein may allow the dishwasher to purchase dishwasher detergent from the marketplace network. In some other examples, the purchase includes the delivery of the purchases items.

In addition, in some embodiments, the received data includes service requirement data associated with an operation of the appliance. The service requirement data may include error codes generated by a diagnostic device and/or module associated with the operation of the appliance. Additionally in some examples, the operations performed by the self-maintaining system of a household appliance device include retrieving, e.g., obtaining, one or more available services from the marketplace network to satisfy the service requirement of the household appliance device, where satisfying the service requirement is meeting the service requirement.

In various circumstances, the example embodiments described herein may resolve various challenges with regards to self-maintaining household appliances as well as vehicles. As such, the example embodiments described herein may resolve problems that did not exist before the availability of the computer networks, particularly the ability of an appliance or a vehicle to detect a need for a service or item and purchase the service or item from a marketplace network based on preauthorized budgets. The operations described herein can be performed by modules that may be implemented with hardware, software, or possibly with aspects of both hardware and software.

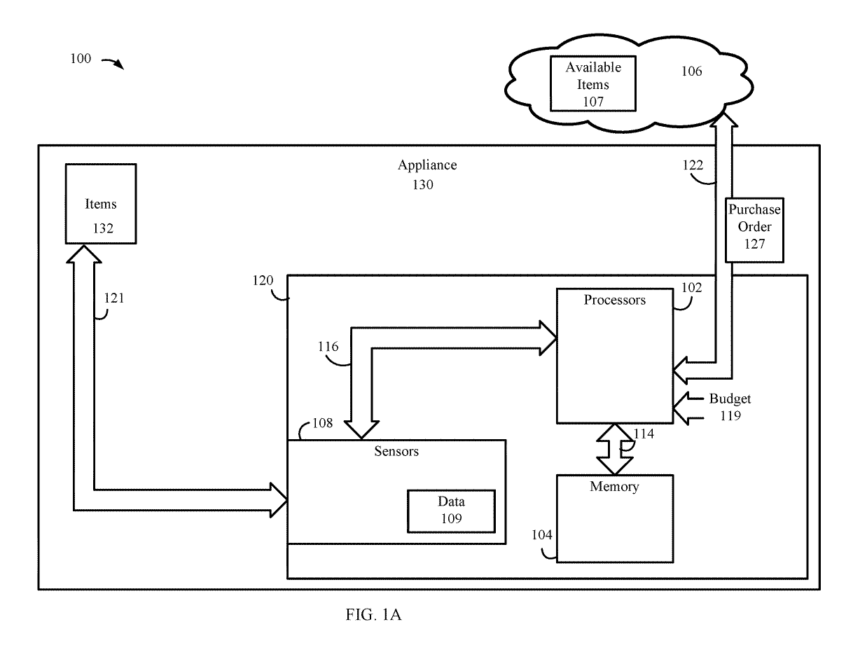

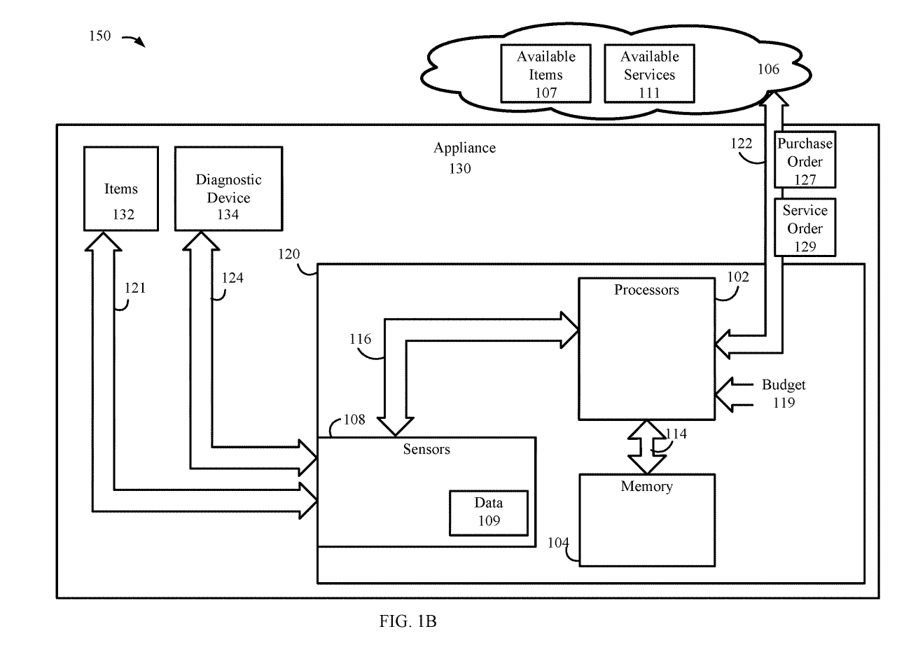

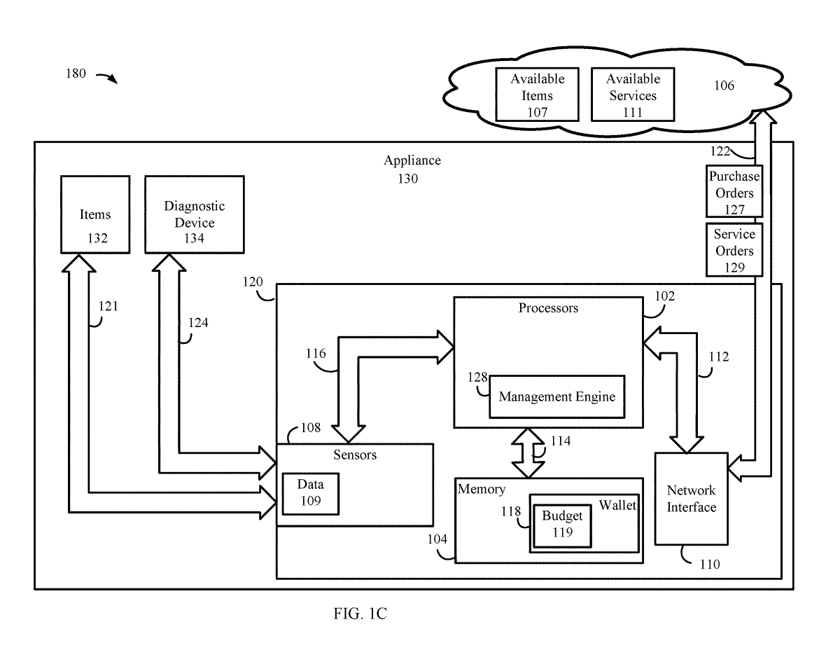

FIG. 1A is a simplified block diagram 100 that includes an exemplary self-maintaining system 120, according to some embodiments. The system 120 may retrieve one or more available items from the marketplace network that are able to satisfy the requirement of an appliance device 130, where satisfying the requirement can mean meeting a predetermined amount or possibly increasing the amount of the one or more items associated with the appliance. In some embodiments, as shown, the system 120 includes one or more processors 102 and the memory 104 that can take the form of a non-transitory memory. The system 120 further includes sensors 108 that are coupled through the connection 116 to the one or more processors 102 such that the one or more processors 102 receive the data 109 generated by the sensors 108. The one or more processors 102 are coupled to memory 104 through connection 114 and may access the memory 114.

In some embodiments, the sensors 108 are coupled to the items 132 of the appliance device 130, e.g., through a connection (e.g., coupling) 121, and the sensors monitor the items 132. In some examples, by monitoring the items 132, the sensors 108 generate data 109 corresponding to the items 132 of the appliance device 130.

In some examples, the sensors 108 are either directly coupled to the memory 104 or are coupled through the one or more processors 102 and via the connections 116 and 114 to the memory 104 and the received data 109 may be stored in the memory 104.

In some embodiments, the sensors 108 of the self-maintaining system 120 are directly coupled to the one or more items 132 of the appliance device 130. Then the sensors 108, through the connection 116, via wires or wirelessly, communicated with the one or more processors 102 of the self-maintaining system 120.

In some embodiments, the one or more processors 102 are coupled through a connection 122 to a marketplace network 106. In some examples, the system 120 identifies one or more available items 107 in the marketplace network 106.

In some embodiments, the system 120 receives data 109 generated by at least one sensor 108 that is associated with the appliance device 130. The received data 109 corresponds to an amount of one or more items 132 of the appliance device 130. Also, a requirement associated with the amount of the one or more items 132 is determined by the system 120. The requirement is determined based at least on the received data 109. The requirement is determined by the one or more processors 102 and based on the received data 109. Then one or more available items 107 are determined from the marketplace network 106 that are able to satisfy the requirement. The one or more available items 107 are determined by the one or more processors 102 through communicating via connection 122 with the marketplace network 106.

In some examples, the appliance is a washing machine 130 and the item 132 is a consumable, e.g., a detergent, required and used by the washing machine 130. The requirement is associated with the amount of the detergent 132 for the washing machine 130 that is determined based on the received data 109 by the sensors 108. Then one or more available items 107, e.g., available detergents, are determined from the marketplace network 106 that are able to satisfy the requirement of the detergent 132. The one or more available items 107 may be associated with brand names, sizes, and prices including delivery prices of the detergent 132 for the washing machine 130. In some examples, a sensor 108 is a gauge, e.g., a laser gauge, monitoring the detergent level within or available to the washing machine.

In some embodiments, an available budget 119 is determined to purchase the one or more available items 107. The available budget 119, which can be set by a user associated with the appliance, is determined by the one or more processors 102. In some examples, the appliance is a washing machine 130 and the item 132 is a detergent required and used by the washing machine 130. The available budget is determined to purchase the available item, e.g., available detergents 107 in the marketplace network 106.

In some embodiments, a purchase order 127 is sent to the marketplace network 106 to retrieve the one or more available items 107. The purchase order 127 is sent by the one or more processors 102. In some examples, the appliance is a washing machine 130 and the item 132 is a detergent required and used by the washing machine 130. The one or more processors 102 sends a purchase order 127 to the marketplace network 106 to retrieve the one or more available items 107. The retrieving may include purchasing and requesting the purchased item to be delivered. In some examples, the budget 119 is retrieved by the one or more processors 102 from the memory 104. Alternatively, the budget 119 is retrieved from a source external to the self-maintaining system 120 by the one or more processors 102 through a network coupled through a network connection to the self-maintaining system 120.

FIG. 1B is a simplified block diagram 150 that includes the exemplary system 120, according to some embodiments. The system 120 may retrieve one or more available items or available services from the marketplace network that are able to satisfy the requirement associated with the amount of the items 132 or the service requirement of the appliance device 130, where satisfying the requirement may be meeting a predetermined amount or possibly increasing the amount of the one or more items 132 associated with the appliance device 130. In some embodiments, as shown, the system 120 includes one or more processors 102 and the memory 104 that can take the form of a non-transitory memory. The system 120 further includes sensors 108 that are coupled through the connection 116 to the one or more processors 102, such that the one or more processors 102 receive the data 109 generated by the sensors. The one or more processors 102 are coupled to memory 104 through connection 114 and may access the memory 114.

In some embodiments, the sensors 108 are coupled to the items 132 of the appliance device 130 and the sensors 108 monitor the items 132. Also, the sensors 108 are coupled, e.g., through the connection 124, to the diagnostic devices 134 of the appliance device 130 and the sensors 108 monitor the diagnostic devices 134. In some examples, the sensors 108 that monitor the items 132 and the diagnostic devices 134 generate data 109 corresponding to the items 132 and the diagnostic devices 134 of the appliance device 130.

In some examples, the sensors 108 of the block diagram 150 are either directly coupled to the memory 104 or are coupled through the one or more processors 102 and via the connections 116 and 114 to the memory 104 and the received data 109 may be stored in the memory 104.

In some embodiments, the one or more processors 102 are coupled through a connection 122 to a marketplace network 106. In some examples, the system 120 identifies one or more available items 107 and/or available services 111 in the marketplace network 106.

In some embodiments, the self-maintaining system 120 determines a requirement associated with the amount of the one or more items 132. The requirement is determined based at least on the received data 109. Also, a service requirement of the appliance device 130 may be determined by the system 120. The service requirement is as well determined based at least on the received data 109. The requirement associated with the amount of the one or more items 132 and the service requirement are determined by the one or more processors 102 and based on the received data 109. Then, one or more available items 107 are determined from the marketplace network 106 that are capable of satisfying the requirement associated with the amount of the one or more items 132. Also, one or more available services 111 are determined from the marketplace network 106 that are able to satisfy the service requirement. The one or more available items 107 and the one or more available services 111 are determined by the one or more processors 102 through communicating via connection 122 with the marketplace network 106.

In some examples, the appliance is a dishwasher 130 and the item 132 is a detergent required and used by the dishwasher 130. The requirement is associated with the amount of the detergent 132 for the dishwasher 130 that is determined based on the received data 109 from the sensors 108. Then one or more available items 107, e.g., available dishwasher detergents, are determined from the marketplace network 106 that are capable of satisfying the requirement of the detergent 132. The one or more available items 107 may include brand name, size, and price including delivery price of the detergent 132 for the dishwasher 130.

In some embodiments, an available budget 119 is determined to purchase the one or more available items 107. The available budget 119 may be determined by the one or more processors 102. In some examples, the appliance 130 is a dishwasher, possibly referred to as the dishwasher 130, and the item 132 is a detergent required and used by the dishwasher 130. The available budget 119 is determined to purchase the available item, e.g., available detergents 107 in the marketplace network 106.

In some embodiments, a purchase order 127 is sent to the marketplace network 106 to retrieve the one or more available items 107. The purchase order 127 is sent by the one or more processors 102. In some examples, the appliance is a dishwasher 130 and the item 132 is a detergent required and used by the dishwasher 130. The one or more processors 102 sends a purchase order 127 to the marketplace network 106 to retrieve the one or more available items, e.g., detergents 107. The retrieving may include purchasing and requesting the purchased item to be delivered.

Likewise, in some examples, a service order 129 is sent to the marketplace network 106 to retrieve the one or more available services 111. The service order 129 is sent by the one or more processors 102. In some examples, the appliance is a dishwasher 130 and the diagnostic device 134 generates a code, e.g., an error code, associated with a service requirement by the dishwasher 130. The one or more processors 102 determine the available services 111 in the marketplace network 106 and send a service order 129 to the marketplace network 106 to retrieve the one or more available services, e.g., maintenance service requirement 111. The retrieving may include requesting the service to be delivered at a specific location.

In some embodiments, the received data 109 includes service requirement data associated with an operation of the appliance device 130. Based at least on the service requirement data, a service requirement of the appliance device 130 is determined. In some examples, the appliance device 130 includes a household appliance device and the service requirement includes a maintenance requirement or a repair service requirement of a household appliance device. Also, one or more services 111 available from the marketplace network 106 are identified. The available services 111 are able to satisfy, e.g., meeting, the service requirement. Additionally, the available budget 119 to obtain the available services 111 is determined and a service order 127 is sent to the marketplace network 106 to retrieve, e.g., obtain, the available services 111. In some examples, two separate budgets are used for the purchase orders 127 of the items and the service orders 129.

FIG. 1C is a simplified block diagram 180 that includes the exemplary system 120, according to some embodiments. The system 120 may retrieve one or more available items 107 or available services 111 from the marketplace network that are able to satisfy the requirement associated with the amount of the items 132 or the service requirement of the appliance device 130. In some embodiments, as shown, the system 120 includes one or more processors 102 and the memory 104 that can take the form of a non-transitory memory. The system 120 includes sensors 108 that are coupled through the connection 116 to the one or more processors 102 such that the one or more processors 102 receive the data 109 generated by the sensors. The one or more processors 102 are coupled to memory 104 through connection 114 and may access the memory 114. The system 120 further includes the network interface 110 that is coupled through the connection 112 to the one or more processors 102. The network interface 110 is coupled through the connection 122 with the marketplace network 106. The one or more processors 102 communicate through the connection 122 with the marketplace network and send service orders 129 and purchase orders 127 to the marketplace network 106 to obtain available services 111 and available items 107.

Additionally, in some embodiments, the memory 104 of the system 120 further includes the wallet 118. The digital wallet 118 is stored in the memory 104 and can be accessed by the one or more processors 102 through the connection 114. The available budget 119 may be determined by the one or more processors 102 from the digital wallet 118. The available budget 119 is determined to purchase the available item 107 or to obtain the available services 111 from the marketplace network 106.

In some embodiments, the sensors 108 of the block diagram 180 are coupled, e.g., through connection (e.g., coupling) 121, to the items 132 of the appliance device 130 and the sensors monitor the items 132. Also, the sensors 108 are coupled, e.g., through connection 124, to the diagnostic devices 134 of the appliance device 130 and the sensors 108 monitor the diagnostic devices 134. In some examples, the sensors 108 by monitoring the items 132 and the diagnostic devices 134 generate data 109 corresponding to the items 132 and the diagnostic devices 134 of the appliance device 130.

In some examples, the appliance is a TV 130 and the item 132 is a TV program required and watched on the TV 130. The requirement is the information, e.g., daily schedule, of the TV programs 132 that is determined based on the received data 109 by the sensors 108. Then one or more available items 107, e.g., available TV programs, are determined from the marketplace network 106 to satisfy, e.g., meeting, the requirement of the TV programs 132. The one or more available items 107 may include name, length, and price including different prices for different show times.

In some examples, the appliance is a TV 130 and a service requirement for the TV is determined based on received data 109 that includes an error code generated by the diagnostic device 134 of the TV. Thus, a service order 129 is a repair service order for the TV that is sent to the marketplace network 106. The one or more processors 102 send the service order 129 to the marketplace network 106 to retrieve the one or more available services, e.g., repair service 111. The retrieving may include requesting the service to be delivered at a specific location.

In some examples, the appliance is a refrigerator 130 and the item 132 is milk that is required and stored in the refrigerator 130. The requirement is the amount of milk 132 that is determined based on the received data 109 by the sensors 108. Then one or more available items 107, e.g., milk containers, are determined from the marketplace network 106 to satisfy, e.g., meeting, the requirement of milk 132. The one or more available items 107 may include name, size, and price including delivery cost. In some examples, a sensor 108 is a tag reader e.g., an RFID tag reader, associated with the refrigerator that periodically reads that existing tags of the items stored in the refrigerator and based on existing RFID tags in the refrigerator, the one or more processors 102 determine the requirement associated with the amount of the items 132 in the refrigerator. In some examples, the one or more processors 102 retrieve the list of the required items that are required to be in the refrigerator from memory 104. Then by comparing the list of required items and the list of RFID tags in the refrigerator, the one or more processors 102 determines the required items that do not exist in the refrigerator. The requirement of the items 132 in the refrigerator may include the required items that do not exist in the refrigerator along with a brand and size of the items.

In some embodiments, the self-maintaining system 120 includes a digital wallet 118 associated with the available budget 119. The available budget 119 includes one or more digital currencies that are stored in the digital wallet 118.

In some embodiments, in response to receiving a confirmation associated with the order, e.g., order confirmation, from the marketplace network 106, the self-maintaining system 120 adjusts the available budget 119 according to the purchase order 127 and/or the service order 129 sent.

In some embodiments, determining the requirement associated with the amount of the one or more items 132 includes determining that an amount of the one or more items is lower than a threshold amount or is zero. The low amount is determined based at least on the received data 109. The one or more available items 107 are purchased to change the low amount of the item to a full or higher amount that at meets the threshold amount or goes above the threshold amount.

In some embodiments, the appliance device 130 includes a household appliance device and the requirement is associated with the one or more items 132 of the household appliance device that includes the at least one appliance sensor 108. In some examples, the appliance device 130 includes at least one of a washing machine, a dryer, a dishwasher, a TV, and a refrigerator.

In some embodiments, the self-maintaining system 120 includes management engine 128 including one or more modules executing on the one or more hardware processors 102 to perform the operations.

In some embodiments, historical data is generated by attaching time stamps to the received data 109 as well as to the purchase orders and service orders and then the historic data is stored in the memory 104. The historic data shows how fast the item is used or how often a service requirement is performed. In some examples, determining the requirement of the one or more items 132 is based on the historical data as well as the received data 109. Additionally, a deadline may be assigned to the requirement of the one or more items 132 based at least on the historical data. The historic data can is used to combine purchase orders and service orders. In some examples, the deadline indicated when the items 132 should be delivered.

In some embodiments, one or more budget rules or constraints are retrieved and before sending any purchase order 127 or service order 129 the orders are checked against the rules and if the orders satisfy the rules, e.g., stay within constraints of the rules, the orders are sent. In some examples, two separate budgets are used for the purchase orders 127 of the items and the service orders 129. Also, the budget rules for ordering the items and services may be different. The budget rule may indicate that no purchase order above $100 can be made for the items. In some other examples, the budget rule may indicate that all service orders above $200 require prior authorization. In some examples, the budget rules are stored in memory 104 and the one or more processors 102 retrieve the rules from memory 104. In some examples, the one or more processors 102 receive the budget rules via the network interface 110 and from a source external to the self-maintaining system 120.

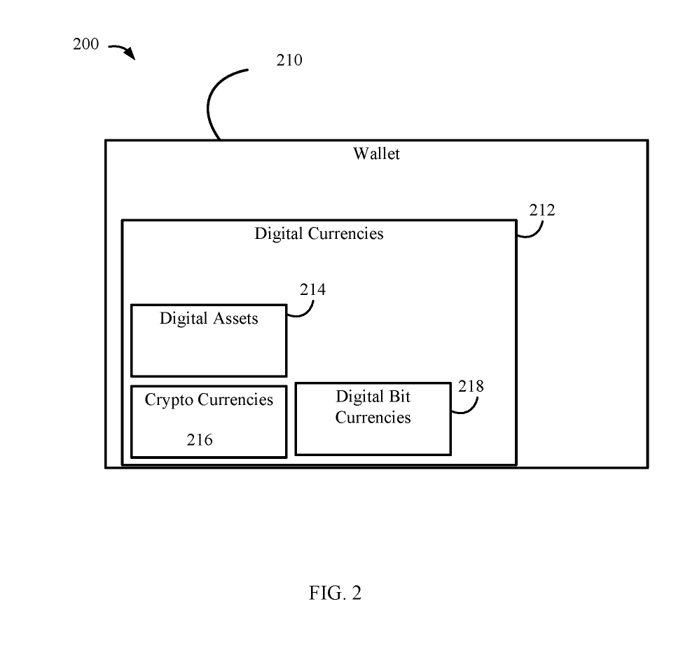

FIG. 2 is a simplified block diagram 200 that includes the exemplary digital wallet 210, according to some embodiments. The digital wallet 210 can take the form of the digital wallet 118 and can be stored in memory 104 of FIG. 1C. In some embodiments, the digital wallet 210 includes digital currencies 212. The digital currencies 212 can include digital assets 214, cryptography currencies 216, and digital bit currencies (e.g., BITCOIN) 218. The digital currencies 212 can take the form of the budget 119 of the FIG. 1C and can be used for purchasing/obtaining available items 107 or available services 111 from the marketplace network 106.

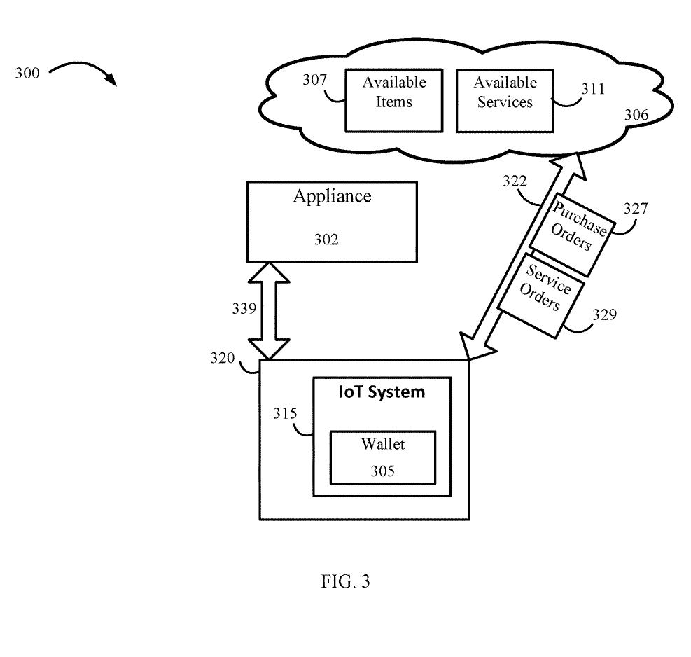

FIG. 3 is a simplified block diagram 300 that includes an exemplary self-maintaining system 320, according to some embodiments. The self-maintaining system 320 is consistent with the self-maintaining system 120 of the FIGS. 1A, 1B, and 1C. In some embodiments, the self-maintaining system 320 further includes an Internet of Things (IoT) system 315. The IoT system 315 further includes the digital wallet 305 that can take the form of the digital wallet 210 of FIG. 2. In some examples, the IoT system 315 uses the digital currencies of the digital wallet 305 to send service orders 329 and purchase orders 327 through connection 322 to retrieve, e.g., obtain/purchase, available items 107 and available services 111.

The block diagram 300 also includes an appliance 302, e.g., a refrigerator, a dishwasher, a dryer, a washer, or a TV. The self-maintaining system 320 also includes sensors consistent with the sensors 108 of the self-maintaining system 120 of the FIGS. 1A, 1B, and 1C that are coupled, e.g., through connection 339, to the items of the appliance 302. The sensors of the self-maintaining system 320 monitor the items of the appliance 302 and generate data related to the items of the appliance 302. Likewise, the sensors 108 monitor the diagnostic devices of the appliance 302 and generates data related to the diagnostic devices of the appliance 302. The generated data is consistent with the generated data 109 of the self-maintaining system 120 of the FIGS. 1A, 1B, and 1C.

In some examples, the digital wallet 305 of the IoT system 315 is consistent with the digital wallet 210 of FIG. 2 that includes digital currencies 212. The IoT system 315 can use the digital currencies 212 in the form of the budget 119 of the FIG. 1C and to be used for sending purchase orders 327 and service orders 329 for purchasing/obtaining available items 307 or available services 311 from the marketplace network 306 to satisfy, e.g., meet, the requirement associated with the amount of the items 132 and the service requirement of the appliance 302. The marketplace 306 is consistent with the marketplace 106 of FIGS. 1A, 1B, and 1C.

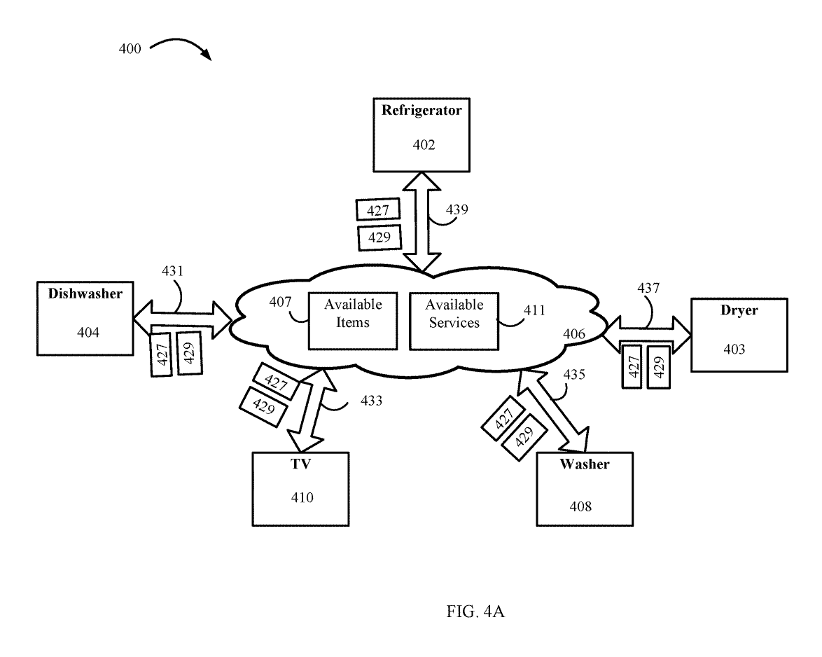

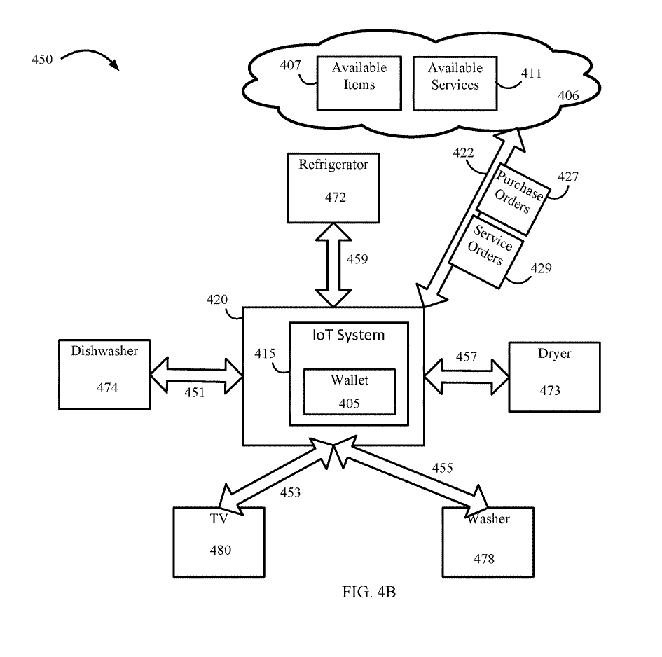

FIG. 4A is a simplified block diagram 400 of an exemplary system of a plurality of self-maintaining appliances, according to some embodiments. The block diagram 400 includes the refrigerator 402, the dishwasher 404, the dryer 403, the washer 408, and the TV 410. Each appliance of FIG. 4A includes a self-maintaining system consistent with the self-maintaining system 120 of FIGS. 1A, 1B, and 1C. The connections 431, 433, 435, 437, and 439 that are consistent with the connection 122 of FIGS. 1A, 1B, and 1C, and thus connect the self-maintaining system of each appliance to the marketplace network 406. The appliances may send purchase orders 427 and service orders 429 that are consistent with purchase orders 127 and service order 129 of FIGS. 1A, 1B, and 1C, to the marketplace network 406. Also, the marketplace 406 is consistent with the marketplace 106 of FIGS. 1A, 1B, and 1C.

In some embodiments, the self-maintaining systems of the refrigerator 402, the dishwasher 404, the dryer 403, the washer 408, and the TV 410 further includes the Internet of Things (IoT) system 315 where the IoT system 315 further includes the digital wallet 305 that can take the form of the digital wallet 210 of FIG. 2. In some examples, the IoT systems 315 of the appliances use the digital currencies of the digital wallets 305 of each appliance to send service orders 429 and/or purchase orders 427 to the marketplace network 406 to purchase/obtain available items 407 and/or available services 411.

In some examples, the home appliance 402, 403, 404, 408, and 410, may communicate through a wireless network and inform the other appliances of their requirement of items 132 and service requirements. Additionally, two or more appliances may combine their service orders into one service order 429 to be sent to the marketplace network 406. Likewise, two or more appliances may combine their purchase orders into one purchase order 427 to be sent to the marketplace network 406.

FIG. 4B is a block diagram 450 including an exemplary self-maintaining system 420 for a plurality of appliances, according to some embodiments. The block diagram 450 also includes the refrigerator 472, the dishwasher 474, the dryer 473, the washer 478, and the TV 480. In contrast to FIG. 1A where each appliance includes a separate self-maintaining system, in the block diagram 450, only one self-maintaining system is used for all the appliances. The block diagram 450 can be used where the appliances are in close proximity of each other, e.g., a house. The self-maintaining system 420 is consistent with the self-maintaining system 120 of FIGS. 1A, 1B, and 1C and thus include the sensors 108 that are coupled, e.g., through connections 451, 453, 455, 457, and 459, to the items of the respective appliances. The sensors 108 of the self-maintaining system 420 monitor the items of the respective appliances and generate data 109 related to the items of the respective appliances. Likewise, the sensors 108 monitor the diagnostic devices of the respective appliances and generates data 109 related to the diagnostic devices of the respective appliances. The generated data is consistent with the generated data 109 of the self-maintaining system 120 of the FIGS. 1A, 1B, and 1C.

In some embodiments, the self-maintaining system 420 in diagram 450 determines the requirement associated with the amount of the one or more items 132 for the respective home appliances 472, 474, 473, 478, and 480. The requirement is determined by the one or more processors 102 of the self-maintaining system 420 and based on the received data 109. Then one or more available items 407 are determined from the marketplace network 406 to satisfy the requirement. The one or more available items 407 are determined by the one or more processors 102 through communicating via connection 422 with the marketplace network 406.

Likewise, in some embodiments, the self-maintaining system 420 determines the service requirement of the respective home appliances 472, 474, 473, 478, and 480. The service requirement is determined by the one or more processors 102 of the self-maintaining system 420 and based on the received data 109. Then one or more available services 411 are determined from the marketplace network 406 to satisfy the service requirement. The one or more available services 411 are determined by the one or more processors 102 through communicating via connection 422 with the marketplace network 406.

In some examples, the self-maintaining system 420 includes the IoT system 415. Also, the digital wallet 305 of the IoT system 415 is consistent with the digital wallet 210 of FIG. 2 that includes digital currencies 212. The IoT system 415 can use the digital currencies 212 in the form of the budget 119 of the FIG. 1C and to be used for sending purchase orders 427 for purchasing/obtaining available items 407 from the marketplace network 406 to satisfy the requirement associated with the amount of the items 132 of the respective home appliances 472, 474, 473, 478, and 480. In addition, The IoT system 415 can use the digital currencies 212 in the form of the budget 119 of the FIG. 1C and to be used for sending service orders 429 for purchasing/obtaining available services 411 from the marketplace network 406 to satisfy the service requirement of the respective home appliances 472, 474, 473, 478, and 480. In some embodiments, the digital currencies 212 is divided into separate budgets for the different home appliances and the purchase order 427 or the service order 429 of each home appliance is sent after determining there is available budget for the intended home appliance. In some examples, a single budget is kept for all the home appliances.

In some examples, when the self-maintaining system 420 determines service requirement, e.g., maintenance service requirement for more than one home appliance 472, 474, 473, 478, or 480, then the self-maintaining system 420 combines the service orders into one service order 429. Likewise, when the self-maintaining system 420 determines requirement associated with the amount of the items 132 for more than one home appliance 472, 474, 473, or 478, then the self-maintaining system 420 combines the purchase orders into one purchase order 427.

In some embodiments, the sensors 108, although part of the self-maintaining system 420, may physically attach to the items 132 of the appliance device 130. The sensors 108 can attach to one or more items of the appliances and through wires or wirelessly communicated with the self-maintaining system 420.

In some embodiments, the self-maintaining system 420 includes or is part of an Internet of Things (IoT) system 415 with a plurality of appliances that include the appliance device 130. The purchase orders 427 and the service orders 429 are generated by the IoT system 415. The purchase orders 427 and the service orders 429 are generated based on the digital currencies of the digital wallet 405 and are sent through the connection 422 to the marketplace network 406.

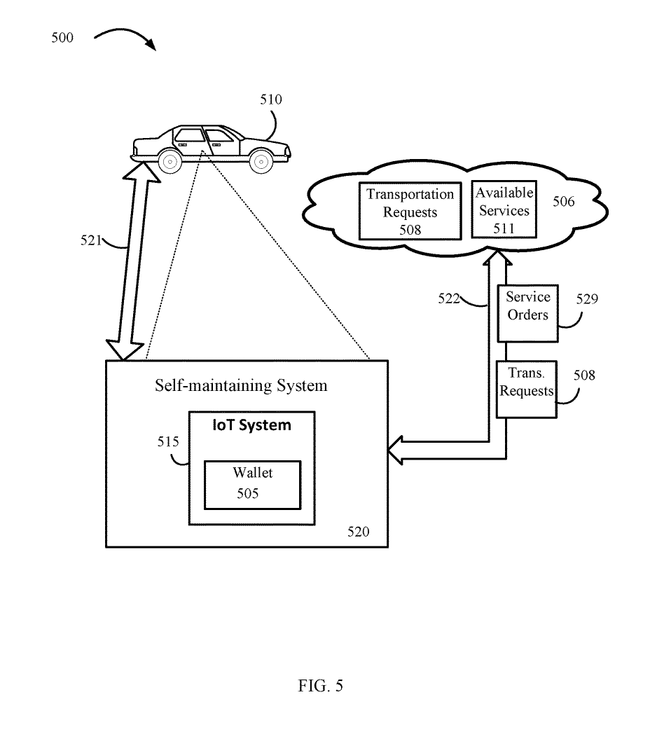

FIG. 5 is a block diagram 500 including an exemplary self-maintaining system 520 for a vehicle, according to some embodiments. The self-maintaining system 520 is consistent with the self-maintaining system 120 of the FIGS. 1A, 1B, and 1C. In some embodiments, the self-maintaining system 520 further includes a digital wallet consistent with the digital wallet 118 of FIG. 1C. In some examples, the self-maintaining system 520 uses the budget 119 of the digital wallet 118 to send service orders 529 to purchase/obtain available services 511 from the marketplace network 506 that is consistent with the marketplace 106 of FIGS. 1A, 1B, and 1C.

The block diagram 500 also includes a vehicle 510. The self-maintaining system 520 also includes sensors consistent with the sensors 108 of the self-maintaining system 120 of the FIGS. 1A, 1B, and 1C that are coupled, e.g., through connection 521, to the vehicle 510. The sensors of the self-maintaining system 520 monitor the diagnostic devices of the vehicle 510 and generate data related to the diagnostic devices of the vehicle 510. The generated data is consistent with the generated data 109 of the self-maintaining system 120 of the FIGS. 1A, 1B, and 1C.

In some examples, the self-maintaining system 520 further includes an Internet of Things (IoT) system 515. The IoT system 515 can further include a digital wallet 505 that can take the form of the digital wallet 210 of FIG. 2. In some examples, the IoT system 515 uses the digital currencies of the digital wallet to send service orders 529.

In some examples, the digital wallet 505 of the IoT system 515 is consistent with the digital wallet the digital wallet 210 of FIG. 2 that includes digital currencies 212. The IoT system 515 can use the digital currencies 212 in the form of the budget 119 of the FIG. 1C and to be used for sending service orders 529 for purchasing/obtaining available services 511 from the marketplace network 506 to satisfy a service requirement of the vehicle 510.

In some embodiments, one or more users are connected through their client devices to the marketplace network 506 and send transportation request 508 through the marketplace network 506 to the vehicle 510. The self-maintaining system 520 of the vehicle 510 receives one or more transportation requests 508 from the marketplace network 506 through the connection 522 to perform the taxi rides.

In some examples, the self-maintaining system 520 determines, e.g., receives one or more transportation requests 508 from one or more users through their user devices. The transportation requests 508 are received by the vehicle 510 via connection 522. Also, after the completion of the transportation requests 508, the self-maintaining system 520 adjusts the available budget of the vehicle 510. Adjusting the available budget by the self-maintaining system 520 includes obtaining digital currencies, e.g., via a wireless network, from the one or more users as a compensation for the transportation. The digital currencies are stored in digital wallet 505 of the self-maintaining system 520.

In some embodiments, transactions with the marketplace network 106, 306, 406, 506, and 606 involving digital currencies 212 are encrypted. In some examples all purchase orders 127, 327, 427 and service orders 129, 329, 429, 529, and 629 sent to the marketplace network are also encrypted.

In some embodiments, the service requirement includes one of an oil service requirement of the vehicle 510, a maintenance service requirement of the vehicle 510, a repair requirement of the vehicle 510, or gasoline requirement associated with a gasoline tank in the vehicle. Additionally, the transportation request 508 from the one or more users includes a transportation of one or more passengers or a transportation of cargo from a first location to a second location.

In some embodiments, the sensor is an odometer of the vehicle 510. Based on the received data from the odometer, the self-maintaining system 520 determines a tune-up service requirement. The vehicle 510 moves to a location associated with the service provider to receive the tune-up service. In some examples, the vehicle 510 is a self-driving vehicle and the vehicle 510 self-drives to receive the tune-up service.

In some embodiments, the sensor is a pressure sensor associated with a tire of the vehicle 510. Based on the received data from the pressure sensor, the self-maintaining system 520 determines a maintenance service requirement. The vehicle 510 moves to a location associated with the service provider to receive the maintenance service. In some examples, the vehicle 510 is a self-driving vehicle and the vehicle 510 self-drives to receive the maintenance service.

In some embodiments, the sensor is a brake sensor, e.g., a thickness sensor to measure a thickness of the brake pads, associated with the vehicle 510. Based on the received data from the brake sensor, the self-maintaining system 520 determines a brake service requirement. The vehicle 510 moves to a location associated with the service provider to receive the brake service. In some examples, the vehicle 510 is a self-driving vehicle and the vehicle 510 self-drives to receive the brake service.

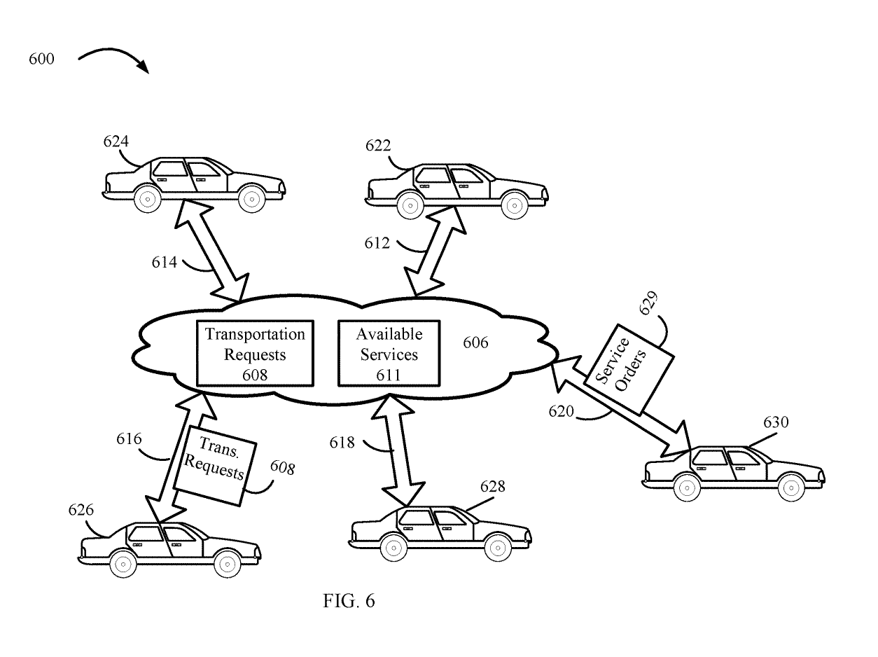

FIG. 6 is a block diagram 600 of an exemplary system of a fleet of self-maintaining vehicles, according to some embodiments. The block diagram 600 includes the vehicles 622, 624, 626, 628, and 630. Each vehicle of FIG. 6 includes a self-maintaining system consistent with the self-maintaining system 520 of FIG. 5. The connections 612, 614, 616, 618, and 620, are consistent with the connection 522 of FIG. 5, and thus connect the self-maintaining system of each vehicle to the marketplace network 606 which is consistent with the marketplace 106 of FIGS. 1A, 1B, and 1C. The vehicles may send service orders 629 that are consistent with service order 129 of FIGS. 1A, 1B, and 1C, to the marketplace network 606.

In some embodiments, the self-maintaining systems of the vehicles 622, 624, 626, 628, and 630, further include an Internet of Things (IoT) system that is consistent with the IoT system 515 of FIG. 5. The IoT system further includes the digital wallet 505 that can take the form of the digital wallet 210 of FIG. 2. In some examples, the IoT systems 515 use the digital currencies of the digital wallets 505 of each vehicle to send service orders 629 to the marketplace network 606 to purchase/obtain available services 611.

In some embodiments, the self-maintaining systems of the vehicles 622, 624, 626, 628, and 630, receive transportation requests 608 from the marketplace network 606 to provide a ride service such as to provide passenger rides.

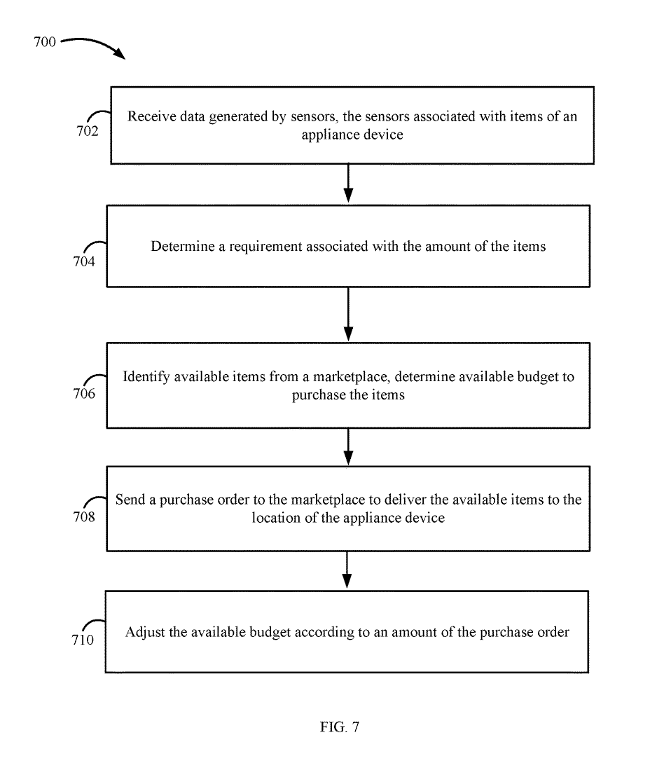

FIG. 7 illustrates an exemplary self-maintaining method 700, according to some embodiments. Notably, one or more steps of the method 700 described herein may be omitted, performed in a different sequence, and/or combined with other methods for various types of applications contemplated herein. The method 700 may be performed by any of the self-maintaining systems 120 or 320 in FIG. 1A, FIG. 1B, FIG. 1C, or FIG. 3. The method 700 can be used as a method of purchasing/obtaining required items for appliances. In some embodiments, one or more processes, e.g., steps of the method 700, is implemented by instructions (e.g., software instructions) stored on the non-transitory memory, e.g., non-transitory memory 104 of FIGS. 1A, 1B, and 1C. In some examples, a management engine executing on the one or more processors 102 of the self-maintaining system 120 execute the steps of the method 700.

As shown in FIG. 7, at step 702, the method 700 may include receiving data generated by sensors. In some examples, as shown in FIGS. 1A, 1B, and 1C, the data is received from one or more sensors 108 and the received data is associated with an appliance device 130. The received data is associated with an item of the appliance device 130 and may be an amount of the item 132. In some examples, the appliance device is a washing machine and the sensor is a gauge, e.g., a laser sensor, measuring the level of an item 132, e.g., a detergent in the washing machine. In some other examples, a sensor 108 is attached on the item 132, e.g., on the detergent container and the sensor 108 is coupled through connection 116, wirelessly or via wire, to the one or more processors of the self-maintaining system 120.

At step 704, the method 700 may include determining a requirement associated with the amount of the items. The requirement is determined based on the received data from sensors. In some examples and as noted above, the received data indicates the amount of the item, e.g., the detergent in the washing machine. When the amount of detergent is low, e.g., lower than a threshold level, then the received data indicates a requirement associated with an amount of the detergent. In some examples, the method may indicate the brand and size of the required detergent as the requirement.

At step 706, the method 700 may include identifying available items from a marketplace and determining available budget to purchase the items. In some examples and as shown in FIGS. 1A, 1B, and 1C, identifying available items may be performed by the self-maintaining system 120 communicating through the connection 122 and finding the available items 107 in the marketplace 106. Determining the available items 107 in the marketplace 106 may include determining the cost of the available items, including the delivery cost. In some examples, the available items are able to satisfy, e.g., meet, the requirement associated with the amount of the items 132. Additionally, the self-maintaining system 120 may determine the available budget 119 to purchase the available items 107. In some examples, the self-maintaining system 120 may retrieve its budget from the memory 104 and determine, e.g., check, if there is sufficient budget to purchase the item. In some examples, the available budget is in the form of digital currencies 212 consistent with FIG. 2. The digital currencies 212 can include digital assets 214, cryptography currencies 216, and digital bit currencies (e.g., BITCOIN) 218. The digital currencies 212 may be stored in a digital wallet in the memory. The digital currencies 212 can be used for paying the price of the purchased items.

At step 708, the method 700 may include sending a purchase order to the marketplace to deliver the available items to the location of the appliance device. The purchase order is sent based on available budget. After determining there is sufficient budget, an order is generated and sent to the marketplace network to retrieve, e.g., deliver, the items. In some examples and as shown in FIG. 1A, generating and sending an order may be performed by the self-maintaining system 120. The order is sent through the connection 122 to the marketplace to retrieve, e.g., purchase and request deliver, of the item 132. In some examples, the appliance is a washing machine and the self-maintaining system 120 associated with the washing machine after determining there is sufficient budget, may send an order to the marketplace 106 to ask for the delivery of the detergent 132 to the washing machine.

At step 710, the method 700 may include adjusting the available budget according to an amount of the purchase order, e.g., associated with the purchase order. In some examples and as shown in FIGS. 1A, 1B, and 1C, adjusting the budget may be performed by the self-maintaining system 120. As discussed above, the available budget may be in the form of digital currencies consistent with digital currencies 212 shown in FIG. 2 that may be stored in a digital wallet 118 in the memory. Therefore, adjusting the budget may include transferring a part of the budget, e.g., transferring a part of the digital currencies 212 through the network connection 122 to the marketplace network 106 as compensation, e.g., payment for the retrieved items from the marketplace network 106. In some examples, adjusting the available budget occurs in response to receiving a confirmation associated with the purchase order, e.g., a purchase order confirmation, from the marketplace network 106.

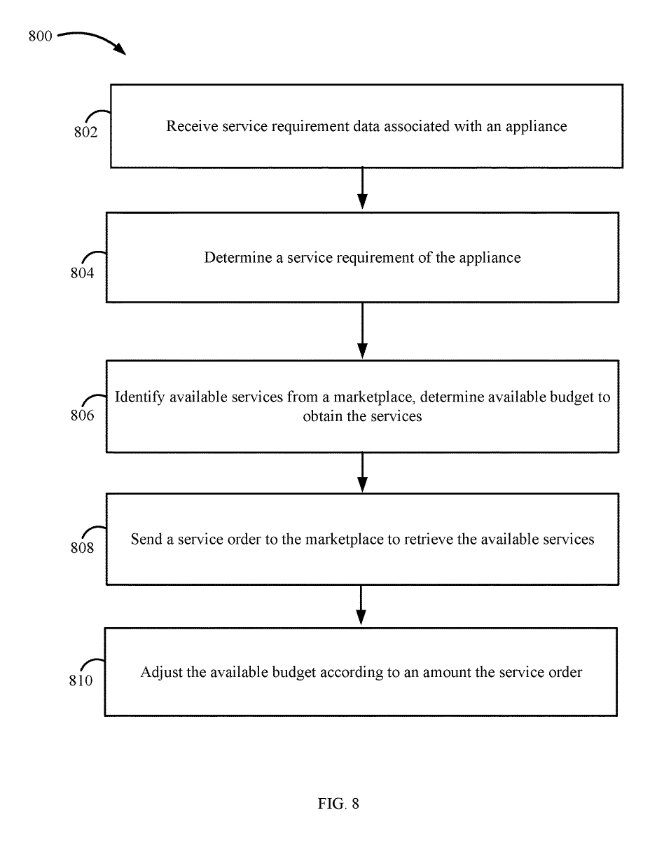

FIG. 8 illustrates an exemplary self-maintaining method 800, according to some embodiments. Notably, one or more steps of the method 800 described herein may be omitted, performed in a different sequence, and/or combined with other methods for various types of applications contemplated herein. The method 800 may be performed by any of the self-maintaining systems 120 or 320 in FIG. 1B, FIG. 1C, or FIG. 3. The method 800 can be used as a method of purchasing/obtaining service requirements for appliances. In some embodiments, one or more processes, e.g., steps of the method 800, is implemented by instructions (e.g., software instructions) stored on the non-transitory memory, e.g., non-transitory memory 104 of FIGS. 1B, and 1C. In some examples, a management engine executing on the one or more processors 102 of the self-maintaining system 120 execute the steps of the method 800.

As shown in FIG. 8, at step 802, the method may include receiving service requirement data generated by sensors. In some embodiments, as shown in FIGS. 1B, and 1C, the data is received from one or more sensors and the received data is associated with an appliance. The received data may be associated with a diagnostic device 134 of the appliance. In some examples, the appliance is a dryer and the sensor is receiving a signal from a diagnostic device of the dryer. In other examples, the diagnostic device is a laser assembly measuring the spinning performance including the speed and uniformity of speed of spinning of the dryer and the sensor receives one or more signals from the laser assembly. In yet other examples, the laser-assembly is part of the sensors 108 that may be installed in the dryer. In some other examples, the sensor 108 is attached to the diagnostic device 134 and the sensor 108 is coupled through connection 116, wirelessly or via wire, to the one or more processors of the self-maintaining system 120.

At step 804, the method may include determining a service requirement of the appliance. The service requirement is determined based on the received data from sensors 108. In some examples and as noted above, the received data from the diagnostic device includes an error code associated with the operation performance of the dryer and based on the error code a service requirement of the dryer is determined. In some other examples and as noted above, the received data is associated with spinning of the dryer and a maintenance service requirement is determined.

At step 806, the method may include identifying available services from a marketplace and determining available budget to obtain the services. The available services are determined to satisfy, e.g., meet, the service requirement. In some examples and as shown in FIGS. 1B, and 1C, identifying available services may be performed by the self-maintaining system 120 communicating through the connection 122 and finding the available services 111 in the marketplace 106. Determining the available services 111 in the marketplace 106 may include determining the cost of the available services, including the cost of the service at the location of the appliance. Additionally, the self-maintaining system 120 may determine the available budget 119 to purchase the available service 111. In some examples, the self-maintaining system 120 may retrieve its budget from the memory 104 and determine, e.g., check, if there is sufficient budget to purchase the service. In some examples, the available budget is in the form of digital currencies 212 consistent with FIG. 2 such that the available budget includes digital assets 214, cryptography currencies 216, and digital bit currencies (e.g., BITCOIN) 218. The digital currencies 212 may be used for paying the price of the purchased services.

At step 808, the method may include sending a service order to the marketplace to retrieve the available services. The service order is sent based on available budget. After determining there is sufficient budget, a service order is generated and sent to the marketplace network to retrieve the services, e.g., deliver the services to the appliance. In some examples and as shown in FIG. 1B, generating and sending a service order may be performed by the self-maintaining system 120. The order is sent through the connection 122 to the marketplace to retrieve, e.g., purchase one of the available services 111. In some examples, the appliance is a dryer and the self-maintaining system 120 associated with the dryer after determining there is sufficient budget, may send a service order to the marketplace 106 to retrieve, e.g., obtain or purchase, the one of the available services 111.

At step 810, the method may include adjusting the available budget according to an amount of the service order. In some examples and as shown in FIGS. 1B, and 1C, adjusting the budget may be performed by the self-maintaining system 120. As discussed above, the available budget may be in the form of digital currencies consistent with digital currencies 212 shown in FIG. 2 that may be stored in a digital wallet 118 in the memory. Therefore, adjusting the budget may include transferring a part of the budget, e.g., transferring a part of the digital currencies 212 via the network connection 122 to the marketplace network 106 as compensation, e.g., payment for the retrieved services from the marketplace network 106. In some examples, adjusting the available budget 119 includes adjusting the one or more digital currencies 212.

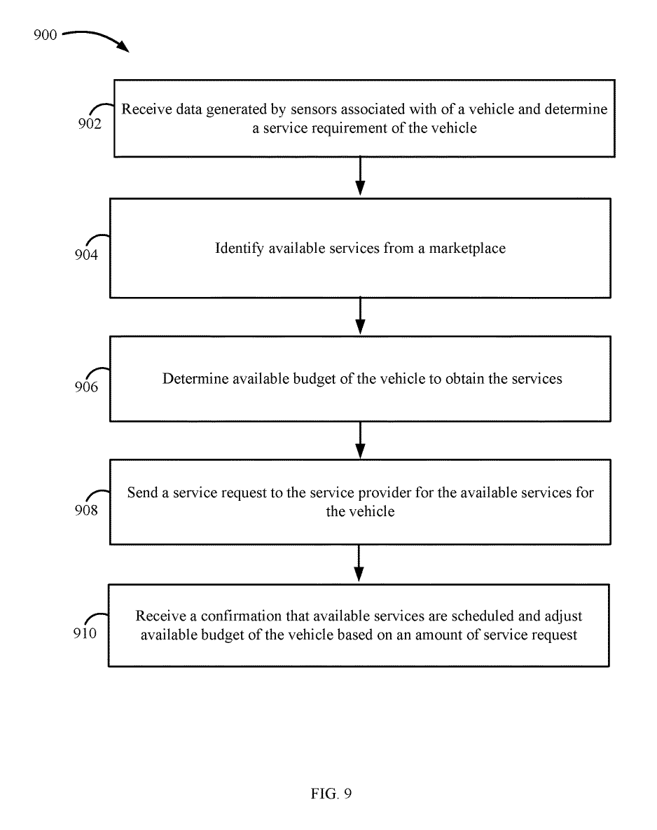

FIG. 9 illustrates an exemplary self-maintaining method 900, according to some embodiments. Notably, one or more steps of the method 900 described herein may be omitted, performed in a different sequence, and/or combined with other methods for various types of applications contemplated herein. The method 900 may be performed by the self-maintaining system 520 in FIG. 5. The method 900 can be used as a method of purchasing/obtaining service requirements for vehicles. In some embodiments, one or more processes, e.g., steps of the method 900, is implemented by instructions (e.g., software instructions) stored on the non-transitory memory, e.g., a non-transitory memory consistent with the non-transitory memory 104 of FIGS. 1A, 1B, and 1C. In some examples, the self-maintaining system 520 in FIG. 5 is consistent with the self-maintaining system 120 in FIGS. 1A, 1B, and 1C.

As shown in FIG. 9, at step 902, the method may include receiving data generated by sensors associated with a vehicle and determining a service requirement of the vehicle. The sensors may be consistent with the sensors 108 and the received data may be consistent with the received data 109 of FIGS. 1B, and 1C. The received data may be associated with a diagnostic device of the vehicle where the diagnostic device may be consistent with the diagnostic device 134 of FIGS. 1B, and 1C. Additionally, the service requirement is determined based on the received data from sensors 108. In some examples, the received data from the diagnostic device includes an error code associated with the operation performance of the vehicle and based on the error code a service requirement of the vehicle is determined. In some examples, the sensor 108 is attached to the diagnostic device 134 and the sensor 108 is coupled through connection 116, wirelessly or via wire, to the one or more processors of the self-maintaining system 120.

At step 904, the method may include identifying available services from a marketplace. In some examples and as shown in FIG. 5, identifying available services may be performed by the self-maintaining system 520 communicating through the connection 522 and finding the available services 511 in the marketplace 506. Determining the available services 511 in the marketplace 506 may include determining the cost of the available services and determining a map data corresponding to locations that provides the available services.

At step 906, the method may include determining available budget of the vehicle to obtain the services. Additionally, the self-maintaining system 520 may determine the available budget to purchase the available service 511. The available budget is consistent with the available budget 119 in digital wallet 118 of FIG. 1C. In some examples, the self-maintaining system 520 may retrieve its budget from the memory 104 and determine, e.g., check, if there is sufficient budget to purchase the service. In some examples, the available budget is in the form of digital currencies 212 consistent with FIG. 2 such that the available budget includes digital assets 214, cryptography currencies 216, and digital bit currencies (e.g., BITCOIN) 218. The digital currencies 212 may be used for paying the price of the purchased services. In some other examples, the available budget is retrieved from digital wallet 505 of FIG. 5.

In some embodiments, the vehicle is a self-driving vehicle and by providing, e.g., sending, the map data of the service location to the vehicle, the vehicle can drive by itself to the service location. As noted above, the map data of the service location may be determined as part of identifying available services.

At step 908, the method may include sending a service request to the service provider for the available services for the vehicle. The service order is sent based on available budget. In some embodiments, after determining there is sufficient budget and the vehicle is at the service provider location, a service order is generated and sent to the service provider to retrieve the services. In some examples and as shown in FIG. 5, generating and sending a service order may be performed by the self-maintaining system 520. The service order 529 is sent through the connection 522 and the marketplace network to the service provider to retrieve, e.g., obtain/purchase one of the available services 511.

At step 910, the method may include receiving a confirmation that available services are scheduled and adjusting the available budget of the vehicle based on an amount of the service request. A confirmation may be received from a service provider that the available services to be performed are scheduled, e.g., scheduled for a specific day and time. In some examples and as shown in FIG. 5, adjusting the budget of the vehicle may be performed by the self-maintaining system 520. As discussed above, the available budget of the vehicle may be in the form of digital currencies consistent with digital currencies 212 shown in FIG. 2 that may be stored in a digital wallet 505 that is consistent with the digital wallet 118 of FIG. 1C. Therefore, adjusting the budget of the vehicle may include transferring a portion of the budget, e.g., transferring a portion of the digital currencies 212 via the network connection 522 through the marketplace network 506 to the service provider as compensation, e.g., payment for the retrieved services from the marketplace network 506.

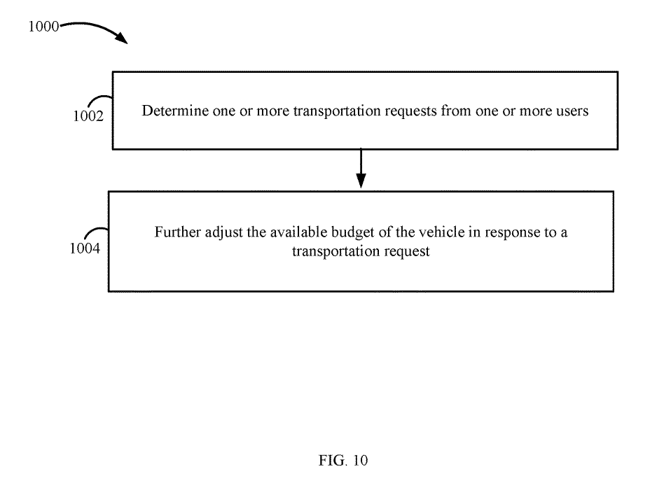

FIG. 10 illustrates an exemplary self-maintaining method 1000, according to some embodiments. Notably, one or more steps of the method 1000 described herein may be omitted, performed in a different sequence, and/or combined with other methods for various types of applications contemplated herein. The method 1000 may be performed by the self-maintaining system 520 in FIG. 5. The method 1000 can be used as a method of providing called services by vehicles. In some embodiments, one or more processes, e.g., steps of the method 1000, is implemented by instructions (e.g., software instructions) stored on the non-transitory memory, e.g., a non-transitory memory consistent with the non-transitory memory 104 of FIGS. 1A, 1B, and 1C. In some examples, the self-maintaining system 520 in FIG. 5 is consistent with the self-maintaining system 120 in FIGS. 1A, 1B, and 1C.

As shown in FIG. 10, at step 1002, the method may include determining one or more transportation requests from one or more users. The one or more transportation requests may include a request for the vehicle to taxi the one or more users. In some embodiments as noted above, the one or more users are connected through their client devices to the marketplace network 506 and place transportation requests 508 in the marketplace. In response to placing the transportation requests 508 to the marketplace, the self-maintaining system 520 of the vehicle 510 may determines, e.g., receives, at least one transportation requests 508 from the marketplace network 506 through the connection 522 to provide a ride service such as to provide passenger rides. In some examples, the transportation request 508 includes a map data of a location to provide the ride for the one or more users. In some other embodiments, the vehicle is a self-driving vehicle and by providing the map data of the location to the vehicle, the vehicle can drive by itself to the location.

At step 1004, the method may include adjusting the available budget of the vehicle after completion of a called service. In some examples and as shown in FIG. 5, adjusting the budget of the vehicle may be performed by the self-maintaining system 520. In some embodiments as noted above, the one or more users are connected through their client devices to the marketplace network 506. Also, the available budget of the vehicle may be in the form of digital currencies consistent with digital currencies 212 shown in FIG. 2 that may be stored in a digital wallet 505 in the memory. Therefore, adjusting the budget of the vehicle may include receiving digital currencies for the one or more users through their client devices and via the network connection 522 and the marketplace network 506 as compensation, e.g., payment for the called service performed by the vehicle.

With the embodiments described herein, after a purchase is made by the vehicle or appliance, a notification may be sent, such as through the system, to a user associated with the vehicle or appliance or associated with an account used by the vehicle or appliance to make the purchase. The notification may be sent to a device of the user, such as smartphone, and may include various details of the purchase, such as, but not limited to, a purchase amount, purchase type, invoice, receipt, and payee. The budget may then be adjusted as needed by the user.

The present disclosure, the accompanying figures, and the claims are not intended to limit the present disclosure to the example embodiments disclosed. As such, it is contemplated that various alternate embodiments and/or modifications to the embodiment disclosed, whether explicitly described or implied herein, are possible in light of the disclosure and/or the figures. Having thus described embodiments of the present disclosure, persons of ordinary skill in the art will recognize that changes may be made to the embodiments disclosed without departing from the scope of the present disclosure.

What is claimed is:

1. A system, comprising:
a non-transitory memory; and
one or more hardware processors coupled to the non-transitory memory and configured to read instructions from the non-transitory memory to cause the system to perform operations comprising:
receiving data generated by at least one sensor associated with an appliance device, wherein the received data corresponds to an amount of one or more items associated with the appliance device;
determining a requirement associated with the amount of the one or more items based at least on the received data;
identifying one or more available items from a marketplace network able to satisfy the requirement associated with the amount;
determining an available budget to purchase the one or more available items; and
sending a purchase order to the marketplace network to retrieve the one or more available items based at least on the available budget.

2. The system of claim 1, wherein determining the requirement associated with the amount of the one or more items comprises determining the amount is lower than a threshold amount, wherein the low amount is determined based at least on the received data, and wherein the one or more available items is configured to change the low amount to a full amount that at least meets the threshold amount.

3. The system of claim 1, wherein the received data comprises service requirement data associated with an operation of the appliance device, and wherein the operations further comprise:
determining a service requirement of the appliance device based at least on the service requirement data;
identifying one or more services available from the marketplace network, wherein the one or more available services is determined to satisfy the service requirement;
determining the available budget to obtain the one or more available services; and
sending a service order to the marketplace network to retrieve the one or more available services based at least on the available budget.

4. The system of claim 3, wherein the appliance device comprises a household appliance device with the at least one sensor, wherein the requirement is associated with the one or more items associated with the household appliance device, wherein the service requirement is associated with the household appliance device, and wherein the service requirement comprises a maintenance requirement or a repair service requirement of the household appliance device.

5. The system of claim 1, wherein the operations further comprise:
in response to receiving a confirmation from the marketplace network associated with the purchase order, adjusting the available budget according to an amount associated with the purchase order.

6. The system of claim 5, wherein the system further comprises a digital wallet that manages the available budget, wherein the available budget includes one or more digital currencies that are stored in the digital wallet, and wherein adjusting the available budget further comprises adjusting the one or more digital currencies based at least on the adjusted available budget.

7. The system of claim 6, wherein the system comprises an Internet of Things (IoT) system with a plurality of appliance devices comprising the appliance device with the at least one sensor, and wherein the operations further comprise:
generating the purchase order and the service order with the IoT system, wherein the purchase order and the service order are sent to the marketplace network based at least on the one or more digital currencies of the digital wallet.

8. The system of claim 1, wherein the appliance device comprises at least one of a washing machine, a dryer, a dishwasher, a TV, and a refrigerator.

9. A system, comprising:
a non-transitory memory; and
one or more hardware processors coupled to the non-transitory memory and configured to read instructions from the non-transitory memory to cause the system to perform operations comprising:
receiving data generated by at least one sensor associated with a vehicle;
determining a service requirement of the vehicle based at least on the received data;
identifying one or more services available from the marketplace network, wherein the one or more available services is able to satisfy the service requirement of the vehicle;
determining an available budget of the vehicle to obtain the one or more available services;
sending a service request to a service provider of the available services for the vehicle based at least on the available budget;
receiving a confirmation that the available services are scheduled; and
adjusting the available budget of the vehicle based on an amount of the service request.

10. The system of claim 9, wherein the operations further comprise:
determining one or more transportation requests from one or more users, wherein the one or more transportation requests includes a request for the vehicle to taxi the one or more users;
further adjusting the available budget of the vehicle in response to a transportation request.

11. The system of claim 9, wherein the system further comprises a digital wallet that manages the available budget, wherein the available budget includes one or more digital currencies that are stored in the digital wallet, and wherein the available budget is adjusted with the one or more digital currencies.

12. The system of claim 9, wherein the service requirement includes at least one of an oil service requirement of the vehicle, a maintenance service requirement of the vehicle, a repair requirement of the vehicle, or a gasoline requirement associated with a gasoline tank of the vehicle.

13. The system of claim 11, wherein the system comprises a fleet of self-sustaining vehicles comprising the vehicle, and wherein the operations further comprise:
generating the service request based at least the one or more digital currencies of the wallet;
wherein adjusting the available budget of the vehicle according to the service request performed further comprises:
transferring a portion of the one or more digital currencies to the service provider in response to the confirmation that the available services are scheduled; and
wherein further adjusting the available budget of the vehicle in response to a transportation request further comprises:
obtaining the digital currencies from the one or more users via the wireless network interface, in response to the completion of the service call.

14. The system of claim 9, wherein the at least one sensor comprises an odometer of the vehicle, wherein the received data is generated by the odometer, wherein the service requirement determined comprises a tune-up service requirement, and wherein the operations further comprises causing the vehicle to move to a location associated with the service provider to receive the tune-up service.

15. The system of claim 9, wherein the at least one sensor comprises a pressure sensor associated with a tire of the vehicle, wherein the received data is generated by the pressure sensor, wherein the service requirement determined comprises a maintenance service requirement, and wherein the operations further comprises causing the vehicle to move to a location associated with the service provider to receive the maintenance service.

16. The system of claim 9, wherein the at least one sensor is a brake sensor associated with brakes of the vehicle, wherein the received data is generated by the brake sensor, wherein the service requirement determined comprises a brake service requirement, and wherein the operations further comprises causing the vehicle to move to a location associated with the service provider to receive the brake service.

17. The system of claim 9, wherein the vehicle is a self-driving vehicle.

18. A method of self-maintaining a device, comprising:
receiving data generated by at least one sensor associated with the device, wherein the received data corresponds to an amount of one or more items;
determining a requirement associated with the amount of the one or more items based at least on the received data;
identifying one or more available items from a marketplace network able to satisfy the requirement associated with the amount;
determining an available budget to purchase the one or more available items;
sending, based on the available budget, a purchase order to the marketplace network to deliver the one or more available items to a location associated with the device; and
in response to receiving a confirmation associated with the purchase order from the marketplace network, adjusting the available budget based at least on the purchase order.

19. The method of claim 18, wherein the received data comprises service requirement data associated with an operation of the appliance device, and wherein the method further comprises:
determining a service requirement of the appliance device based at least on the received data;
identifying one or more available services from a marketplace network determined to satisfy the service requirement;
determining the available budget to obtain the one or more available services;
sending a service order to the marketplace network to retrieve the one or more available services; and
adjusting the available budget according to an amount associated with the service order.

20. The method of claim 18, wherein determining the requirement associated with the amount of the one or more items comprises determining the amount is lower than a threshold amount, wherein the low amount is determined based at least on the received data, and wherein the one or more available items is configured to change the low amount to a full amount that at least meets the threshold amount.
